(19) United States
(12) Patent Application Publication
(10) Pub. No.: US 2025/0387766 A1
(43) Pub. Date: Dec. 25, 2025

(54) DEVICES FOR MULTI-STAGE STRAW MIXING AND DISPENSING IN BEVERAGE PRODUCTION AND ASSOCIATED METHODS

(71) Applicant: BOTRISTA, INC., San Francisco, CA (US)

(72) Inventors: Wu-Chou KUO, San Francisco, CA (US); Yu-Wei CHEN, New Taipei City (TW)

(21) Appl. No.: 19/075,690

(22) Filed: Mar. 10, 2025

Related U.S. Application Data
(60) Provisional application No. 63/661,669, filed on Jun. 19, 2024.

(51) Int. Cl. B01F 29/31; B01F 23/233; B01F 35/41; B01F 101/14

(52) U.S. Cl. CPC B01F 29/31; B01F 23/23314; B01F 35/4111; B01F 2101/14

(57) ABSTRACT

Ingredient blending devices and associated methods are disclosed herein. In some embodiments, an ingredient blending device includes a cup holder assembly, a straw displacement assembly, a gas pumping assembly, and a controller. The controller can be configured to (i) operate the straw displacement assembly to position a straw such that a proximal end of the straw is adjacent the gas pumping assembly and a distal end of the straw is at least partially inside a cup, (ii) operate the cup holder assembly to move the cup relative to the straw, (iii) operate the gas pumping assembly to pump the gas into the proximal end of the straw such that the gas exits at the distal end of the straw and into ingredients in the cup, thereby blending the ingredients, and (iv) operate the straw displacement assembly to dispense the straw into the cup.

### CROSS-REFERENCE TO RELATED APPLICATION(S)

The present application claims the benefit of U.S. Provisional Patent Application No. 63/661,669, filed Jun. 19, 2024, the disclosure of which is incorporated herein by reference in its entirety.

### TECHNICAL FIELD

The present technology relates generally to beverage production and, in particular, to devices for multi-stage straw mixing and dispensing.

### BACKGROUND

For many consumers, freshly made beverages are more appealing than factory-produced canned or bottled beverages for various reasons, including freshness, taste, and flexibility of customizing ingredient combinations. Therefore, many restaurants and beverage vendors offer a variety of freshly made beverages to meet the needs of their customers. As a result of rising labor costs and other factors (e.g., increased operating costs due to impacts of the pandemic or inflation), many restaurants and beverage vendors have begun to use a variety of machinery and equipment to provide or assist in the preparation of freshly made beverages in order to reduce the required labor time and costs.

Blending different ingredients is required for many beverages. However, blending ingredients can be a labor-intensive and time-consuming task, even if using a blending machine. For example, many restaurants and beverage vendors continue to rely on employees to manually put ingredients in a blending machine, wait for the blending machine to finish blending, and pour the blended contents into a cup from the blending machine. Employees must also clean the blending machine between different beverages to avoid cross-contamination, adding to the total labor and time required. Therefore, there is a need for solutions that can automate the blending of ingredients.

### BRIEF DESCRIPTION OF THE DRAWINGS

Features, aspects, and advantages of the presently disclosed technology may be better understood with regard to the following drawings.

FIG. 1 is a schematic block diagram of an ingredient blending device, configured in accordance with embodiments of the present technology.

FIG. 2 is a partially schematic illustration of an ingredient blending device, configured in accordance with embodiments of the present technology.

FIG. 3 is a perspective view of a cup holder assembly, configured in accordance with embodiments of the present technology.

FIG. 4 is a perspective view of another cup holder assembly, configured in accordance with embodiments of the present technology.

FIGS. 5A-5G illustrate a series of operation steps of the ingredient blending device of FIG. 2 in accordance with embodiments of the present technology.

FIG. 6 is a perspective view of yet another cup holder assembly, configured in accordance with embodiments of the present technology.

FIGS. 7A-7H illustrate a series of operation steps of an ingredient blending device including the cup holder assembly of FIG. 6 in accordance with embodiments of the present technology.

FIG. 8 is a partially schematic illustration of another ingredient blending device, configured in accordance with embodiments of the present technology.

FIG. 9 is a top view of a motorized straw nozzle, configured in accordance with embodiments of the present technology.

FIG. 10 is a partially schematic illustration of an ingredient blending device including the motorized straw nozzle of FIG. 9 and configured in accordance with embodiments of the present technology.

FIG. 11 is a flowchart illustrating a method for preparing a blended beverage in accordance with embodiments of the present technology.

FIG. 12 is a block diagram illustrating an overview of devices on which some implementations can operate.

FIG. 13 is a block diagram illustrating an overview of an environment in which some implementations can operate.

FIG. 14 is a block diagram illustrating components that, in some implementations, can be used in a system employing the disclosed technology.

A person skilled in the relevant art will understand that the features shown in the drawings are for purposes of illustrations, and variations, including different and/or additional features and arrangements thereof, are possible.

### DETAILED DESCRIPTION

Embodiments of the present technology are directed to devices and methods for multi-stage straw mixing and dispensing in beverage production. Blending different ingredients is necessary for preparing many popular beverages, such as smoothies, cocktails, coffees, fruit-based drinks, slushies, and more. However, many restaurants and beverage vendors today still rely on employees to manually put ingredients in a blending machine, wait for the blending machine to finish, and pour the blended ingredients into individual cups. Employees may also need to clean the blending machine between each beverage produced to avoid cross-contamination. This can make blending ingredients a labor-intensive and time-consuming process.

Embodiments of the present technology address at least some of the above-described issues for blending ingredients. For example, an ingredient blending machine configured in accordance with embodiments of the present technology dispenses the ingredients to be blended directly into a cup to be served to a customer, automatically blends the ingredients in the cup using a straw, and dispenses the straw into the cup for use by the customer.

In some embodiments, an ingredient blending device includes a cup holder assembly configured to support a cup, a straw displacement assembly positioned to move a straw relative to the cup, a gas pumping assembly positioned to pump gas through the straw, and a controller operably coupled to the cup holder assembly, the straw displacement assembly, and the gas pumping assembly. The controller can be configured to (i) operate the straw displacement assembly to position the straw such that a proximal end of the straw is adjacent the gas pumping assembly and a distal end of the straw is at least partially inside the cup, and (ii) operate the cup holder assembly to move the cup relative to the straw. The controller can be further configured to (iii) operate the gas pumping assembly to pump the gas into the proximal end of the straw such that the gas exits at the distal end of the straw and into ingredients in the cup, thereby blending the ingredients, and (iv) operate the straw displacement assembly to dispense the straw into the cup.

In some embodiments, a method for preparing a blended beverage includes (i) positioning a straw such that a distal end of the straw is at least partially inside a cup, (ii) pumping gas into a proximal end of the straw such that the gas exits at the distal end of the straw and into ingredients in the cup, thereby blending the ingredients, and (iii) dispensing the straw into the cup.

Embodiments of the present technology improve the ingredient blending process for both beverage vendors, employees, and consumers. For vendors, the ingredient blending process is handled by devices as opposed to employees and/or staff members, thus decreasing labor needs. For employees, time and labor associated with blending ingredients and cleaning is saved, thus allowing employees to spend more time with other matters, such as engaging customers. For consumers, ingredients are blended by devices, thus allowing beverages to be produced faster and with a smaller risk of error (e.g., incorrect ingredient proportions). Moreover, because the ingredients are blended in the cup and using the straw that is ultimately served to the customer, as opposed to blended inside the device or using a component of the device, both the need to clean the device between each beverage produced and the risk of cross-contamination are eliminated or at least significantly reduced.

In the Figures, identical reference numbers identify generally similar, and/or identical, elements. Many of the details, dimensions, and other features shown in the Figures are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

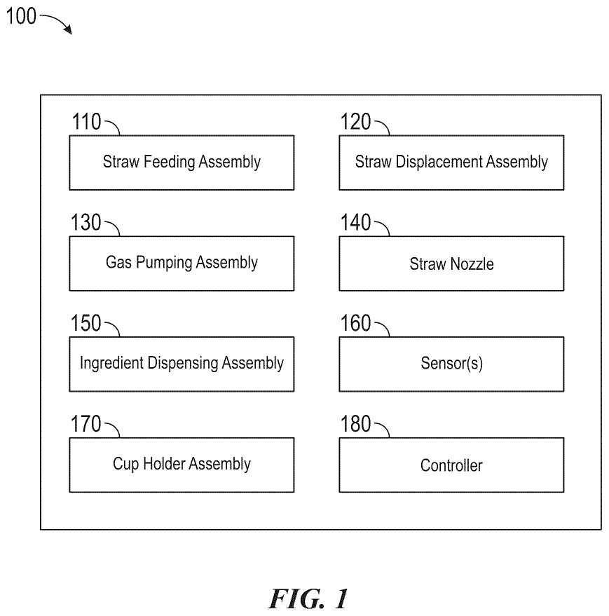

FIG. 1 is a schematic block diagram of an ingredient blending device 100, configured in accordance with embodiments of the present technology. The ingredient blending device 100 can include a straw feeding assembly 110, a straw displacement assembly 120, a gas pumping assembly 130, and a straw nozzle 140. The ingredient blending device 100 can also include an ingredient dispensing assembly 150, one or more sensors 160, a cup holder assembly 170, and one or more controllers. The cup holder assembly 170 can receive and support a cup (e.g., a plastic cup, a paper cup, a metal cup, a mug) to be served to a consumer. The straw feeding assembly 110, the straw displacement assembly 120, and/or the straw nozzle 140 can be positioned above the cup holder assembly 170 such that a straw can be lowered into the cup for blending ingredients, as discussed further herein. The one or more controllers 180 can be shared by the other components of the ingredient blending device 100, and/or can be part of the other components of the ingredient blending device 100 (e.g., the straw displacement assembly 120 can include a first controller and the gas pumping assembly 130 can include a second controller).

During operation of the ingredient blending device 100, the cup holder assembly 170 can receive a cup from an employee or customer and hold the cup in a secure manner. The ingredient dispensing assembly 150 can then dispense the ingredients to be blended (e.g., water, sparkling water, syrup, caramel, sugar, fruit juice, etc.) into the cup. In some embodiments, the one or more sensors 160 are used to ensure that the correct ingredients are dispensed in the proper proportions. The straw feeding assembly 110 can feed a straw (e.g., one at a time) to the straw displacement assembly 120. In some embodiments, the ingredient blending device 100 includes a hopper or other space for storing straws. Additionally or alternatively, the straw can be sourced from outside the ingredient blending device 100. The straw displacement assembly 120 can then move the straw through the straw nozzle 140, which can hold (e.g., suspend) the straw at least partially within the cup containing the ingredients to be blended.

The gas pumping assembly 130 can subsequently pump gas (e.g., air) into one end of the straw (e.g., held by the straw nozzle 140) such that the gas exits through the other end of the straw and into the ingredients, thereby agitating and blending the ingredients. In some embodiments, the cup holder assembly 170 moves (e.g., moves laterally, tilts, rotates) the cup while the gas pumping assembly 130 pumps the gas through the straw to ensure uniform and sufficient blending of the ingredients. In some embodiments, the ingredient blending device 100 further includes a straw moving mechanism to rotate or otherwise move the straw to stir the ingredients for better blending. Once the ingredients are sufficiently blended, the straw displacement assembly 120 can push the straw that was used for blending fully out of the ingredient blending device 100 and dispense the straw into the cup for use by the consumer. The employee or customer can then retrieve the cup with the straw and the produced beverage including the blended ingredients.

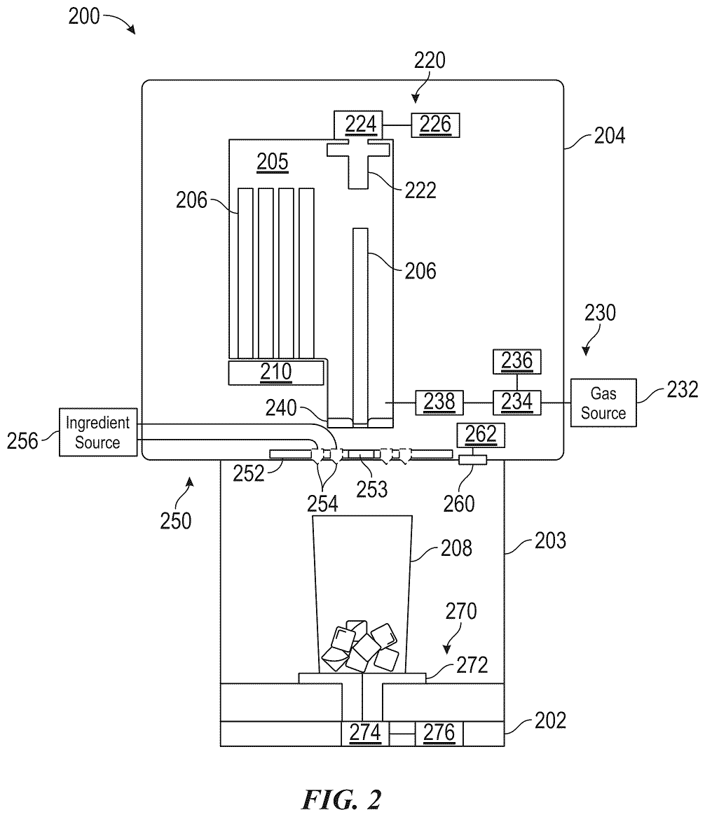

It is appreciated that FIG. 1 merely illustrates one example of the ingredient blending device 100, and that certain components can be omitted, certain components can be replaced by different components, and/or additional components not necessarily illustrated herein can be included. FIGS. 2-8 illustrate various examples of ingredient blending devices configured in accordance with embodiments of the present technology and their operation.

FIG. 2 is a partially schematic illustration of an ingredient blending device 200, configured in accordance with embodiments of the present technology. The ingredient blending device 200 can be an example of the ingredient blending device 100 shown in FIG. 1, and similarly numbered components can have identical or generally similar functions. In the illustrated embodiment, the ingredient blending device 200 includes a base 202, a stem 203 extending upward from the base 202, and a housing 204 supported on the stem 203. The ingredient blending device 200 can include a straw feeding assembly 210, a straw displacement assembly 220, a gas pumping assembly 230, and a straw nozzle 240. The ingredient blending device 200 can also include an ingredient dispensing assembly 250 and one or more sensors 260 at least partially exposed on a bottom surface of the housing 204. The ingredient blending device 200 can further include a cup holder assembly 270 supported in and/or on the base 202. As shown, the cup holder assembly 270 can support a cup 208, which may optionally contain ice.

In the illustrated embodiment, the housing 204 includes an internal storage area or hopper 205 for storing a plurality of straws 206. The straws 206 can be generally linear in shape, and can include plastic straws, paper straws, metal straws, and/or the like. The straw feeding assembly 210 can be disposed around and/or at least partially within the hopper 205. The straw feeding assembly 210 can include grippers, belts, springs, suction cups, pneumatic devices, rotary dispensers, and/or other mechanisms for feeding the straws (e.g., one by one) towards the straw displacement assembly 220. The straw displacement assembly 220 can include an arm 222 (e.g., a piston), an actuator 224 (e.g., a linear actuator) operably coupled to extend or withdraw the arm 222, and a controller 226 operably coupled to control the actuator 224.

The gas pumping assembly 230 can include a pump 234 (e.g., an air pump), a controller 236 operably coupled to control the pump 234, and a valve 238 (e.g., a one-way valve) coupled between the pump 234 and the hopper 205 (e.g., downstream of the pump 234). In some embodiments, the housing 204 can include an opening such that the pump 234 can be in fluid communication with a gas source 232 (e.g., an air tank, the environment). The straw nozzle 240 can include an elastic, flexible, and/or actuatable member that can slidably receive one of the straws 206 and hold the straw while forming a fluid-tight seal therebetween.

The ingredient dispensing assembly 250 can include a nozzle cover 252 coupled to a lower portion (e.g., a bottom surface) of the housing 204 and a plurality of dispensing nozzles 254 coupled thereto. The dispensing nozzles 254 can be positioned above and facing the cup 208. The nozzle cover 252 can include an opening 253 through which the straw 206 can pass therethrough. In some embodiments, the housing 204 can include one or more openings such that the plurality of dispensing nozzles 254 can be in fluid communication with one or more ingredient sources 256. Different ones of the dispensing nozzles 254 can be coupled to dispense different ingredients.

The one or more sensors 260 can be coupled to the lower portion (e.g., the bottom surface) of the housing 204 such that the sensors 260 are positioned to generally face the cup 208. A controller 262 can be operably coupled to receive measurement data from the sensors 260 and communicate the received measurement data to other components of the ingredient blending device 200 (e.g., the controller 226) and/or components external to the ingredient blending device 200. The sensors 260 can include imaging sensors (e.g., cameras, machine vision), distance sensors, and/or the like.

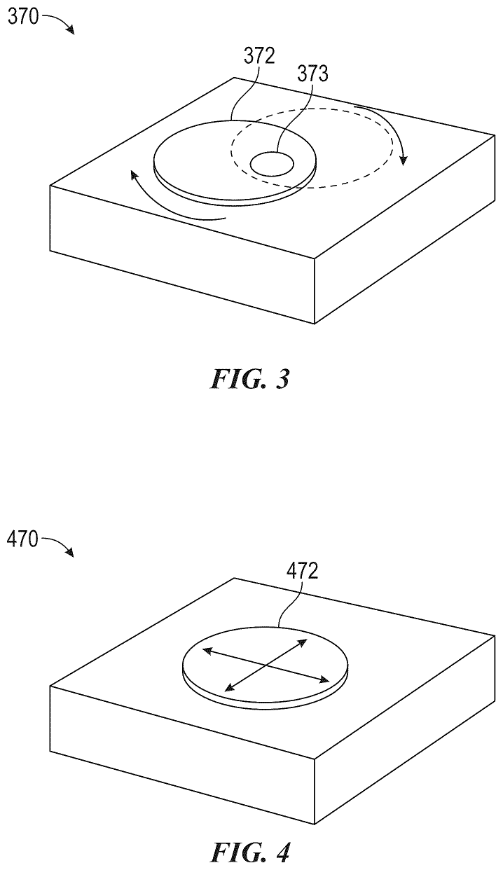

The cup holder assembly 270 can include a cup support 272, an actuator 274 operably coupled to move the cup support 272, and a controller 276 operably coupled to control the actuator 274. The cup support 272 can include a platform, grippers, vacuum suction features, a cage, and/or other component that interfaces and holds the cup 208 in a secure manner during operation of the ingredient blending device 200. As discussed in further detail below, FIGS. 3 and 4 illustrate example configurations of the cup holder assembly 270.

FIGS. 3 and 4 are perspective views of example cup holder assemblies, configured in accordance with embodiments of the present technology. The cup holder assembly 370 of FIG. 3 and the cup holder assembly 470 of FIG. 4 can be examples of the cup holder assembly 270 of FIG. 2. Referring first to FIG. 3, the cup holder assembly 370 includes a cup support 372 in the shape of a flat, circular platform and a pivot 373 coupled to the cup support 372. Notably, the cup support 372 and the pivot 373 are coupled off-center but still overlapping, such that when an actuator (e.g., the actuator 274 of FIG. 2) rotates the pivot 373 about a longitudinal axis of the pivot 373, the cup support 372 rotates and moves along various positions relative to the pivot 373, as indicated by the phantom circle and arrows. Therefore, and as discussed further herein, the cup holder assembly 370 can simultaneously spin and move the cup 208 during operation of the ingredient blending device 200 to achieve more uniform blending. Referring next to FIG. 4, the cup holder assembly 470 includes a cup support 472 in the shape of a flat, circular platform. An actuator (e.g., the actuator 274 of FIG. 2) can move the cup support 472 laterally along multiple linear directions (e.g., x-y directions), as indicated by the arrows.

It is appreciated that FIGS. 3 and 4 merely illustrate examples, and that a cup holder assembly configured in accordance with embodiments of the present technology can have a different set of features. For example, a cup holder assembly can have a combination of select features of the cup holder assemblies 370, 470 such that an actuator can simultaneously rotate a cup support about an off-center pivot (e.g., FIG. 3) and move the cup support along multiple linear directions (e.g., FIG. 4). In some embodiments, the cup support can have different shapes, such as rectangular, hexagonal, etc. In some embodiments, an actuator can move the cup support in various other motions, such as rotating the cup support about an off-center, non-overlapping axis, tilting the cup support about a horizontal axis, etc.

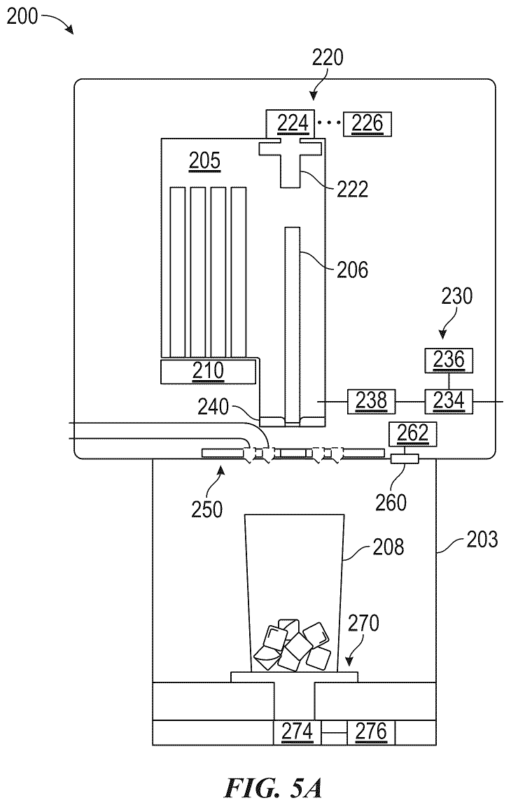

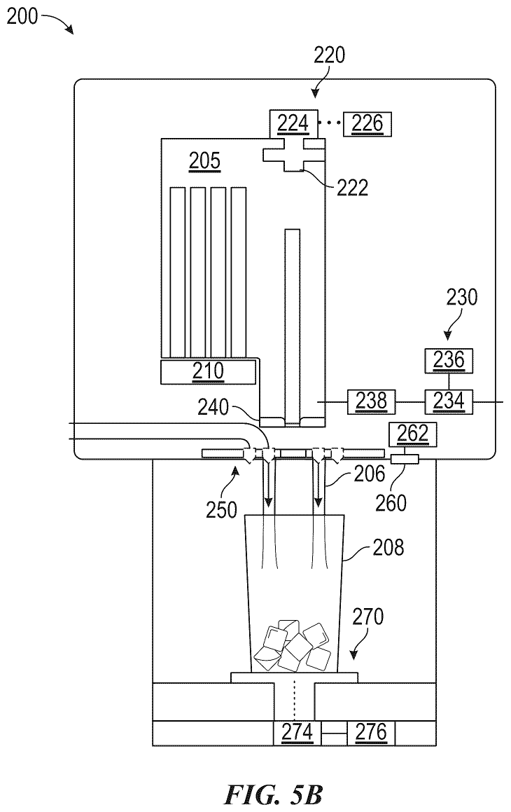

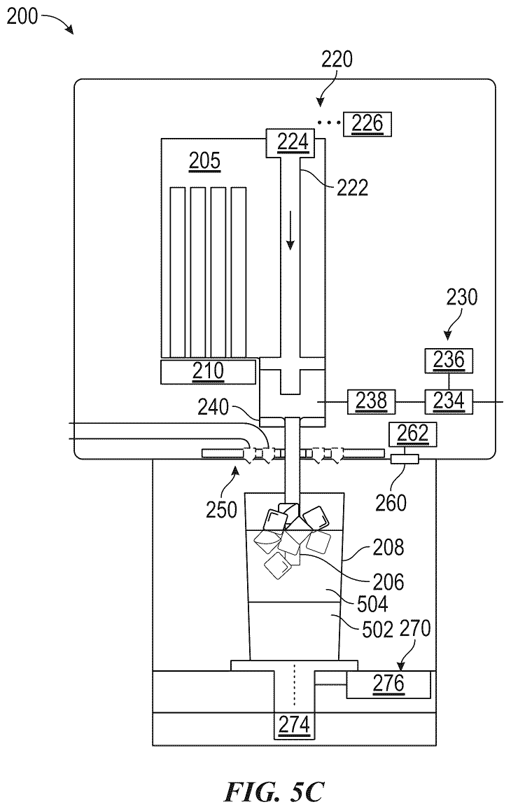

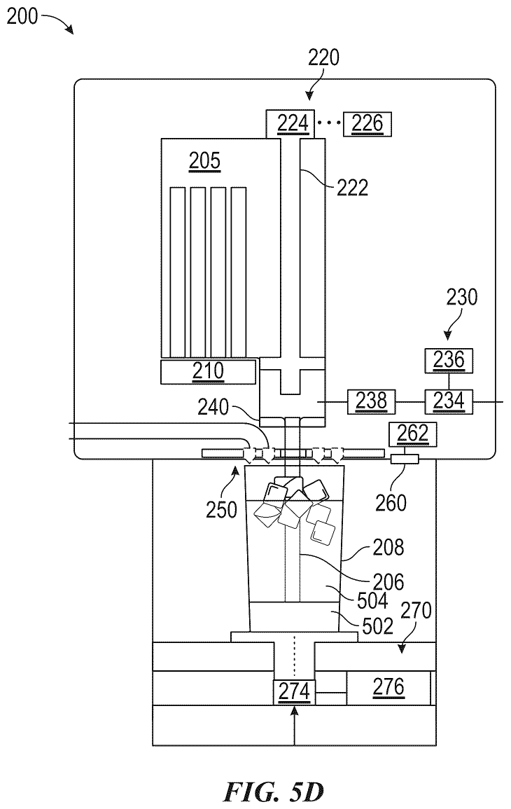

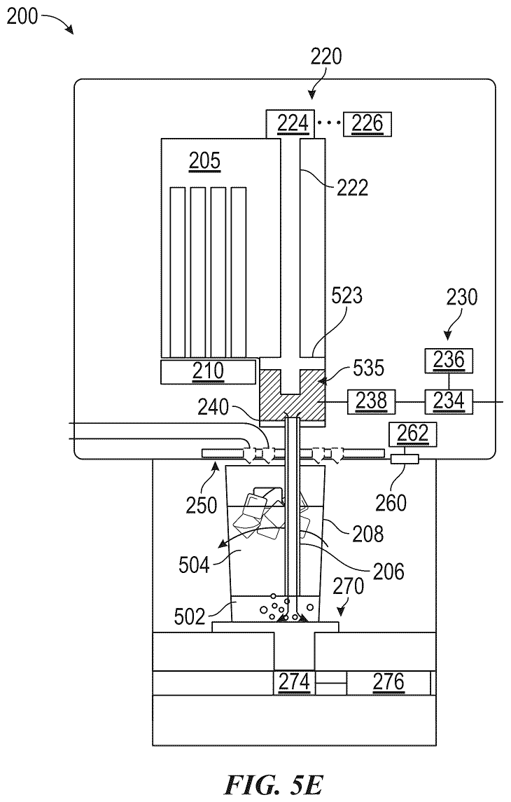

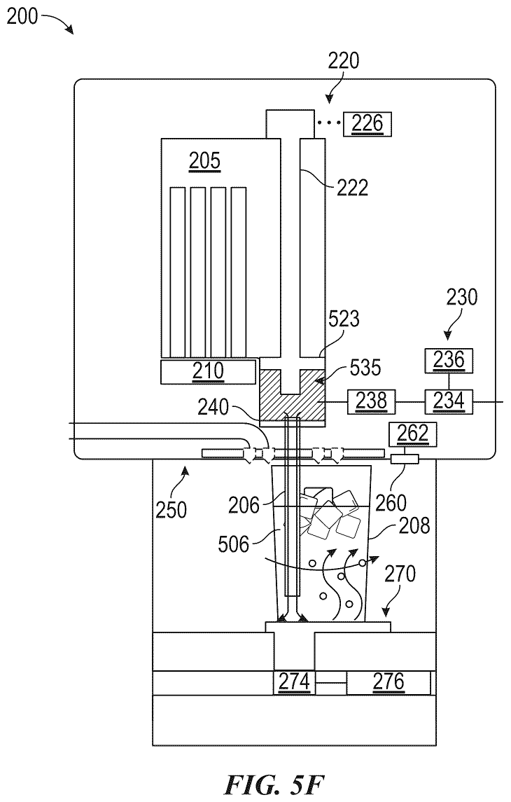

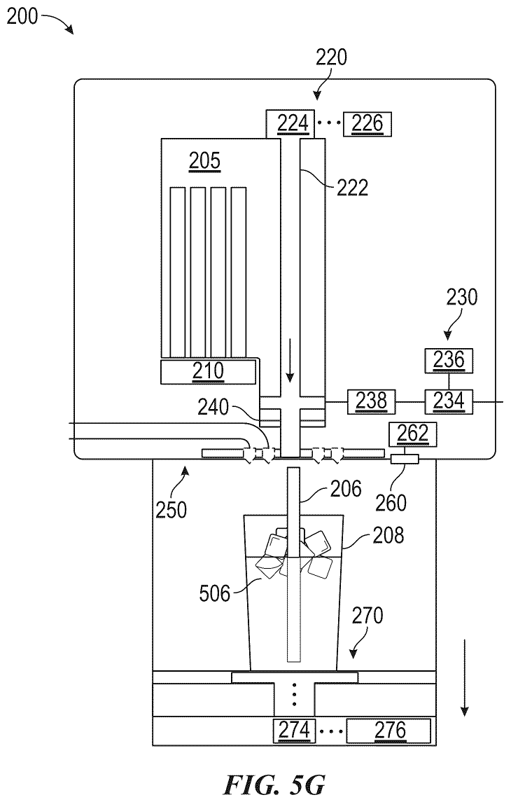

FIGS. 5A-5G illustrate a series of operation steps of the ingredient blending device 200 in accordance with embodiments of the present technology. While the operation steps are illustrated herein in a particular order, it is appreciated that the ingredient blending device 200 can be operated in a different order and/or operated with fewer, alternative, and/or additional steps.

Referring first to FIG. 5A, a user (e.g., a beverage vendor employee, a consumer) can place the cup 208 (optionally pre-filled with ice) on the cup holder assembly 270. The straw feeding assembly 210 can be operated to feed (e.g., move) one of the straws 206 from the hopper 205 to a position between the arm 222 and the straw nozzle 240, as shown. In some embodiments, the straw feeding assembly 210 holds the straw 206 in the illustrated position until the next operation step. In some embodiments, the straw 206 is inserted at least partially into the straw nozzle 240, and the straw nozzle 240 can independently hold the straw 206 in the illustrated position until the next operation step.

Referring next to FIG. 5B, the ingredient dispensing assembly 250 can be operated to dispense the ingredients to be blended into the cup 208 via the dispensing nozzles 254. Different ones of the dispensing nozzles 254 can be coupled to dispense different ingredients. In some embodiments, the ingredients are dispensed in a particular order. In some embodiments, the ingredients are dispensed simultaneously.

Referring next to FIG. 5C, once the ingredient dispensing assembly 250 has completed dispensing the ingredients, the cup 208 may contain different ingredient layers that are not yet blended, such as a first ingredient layer 502 at the bottom of the cup 208 and a second ingredient layer 504 above the first ingredient layer 502. The controller 226 can operate the actuator 224 to lower the arm 222 such that the arm 222 contacts a proximal end of the straw 206 and pushes the straw 206 to a lower position. In particular, the arm 222 can push the straw 206 partially out of the housing 204 and partially into the cup 208 (and into the first ingredient 502 and/or the second ingredient 504 therein) until the straw nozzle 240 holds the proximal end of the straw 206. In some embodiments, the sensors 260 are used to measure the position of the straw 206 (e.g., in real time, at certain points in time) to ensure that the straw 206 is pushed by the arm 222 to the appropriate position. A feedback loop can be formed in which measurements from the sensors 260 are communicated to the controller 226 by the controller 262. As discussed in further detail herein, the actuator 224 can then raise the arm 222 (e.g., away from the cup holder assembly 270) to form a gap between the proximal end of the straw 206 and the arm 222, as shown.

Referring next to FIG. 5D, the controller 276 can operate the actuator 274 to raise the cup support 272, and thus the cup 208, vertically upward relative to the base 202, as indicated by the arrow. As a result, the straw 206, which remains in the same position illustrated in FIG. 5C, is positioned deeper in the cup 208 such that, e.g., a distal end of the straw 206 is positioned adjacent to the bottom surface of the cup 208. In some embodiments, the sensors 260 can be used to measure the position of the straw 206 (e.g., in real time, at certain points in time) to ensure that the straw 206 is at the appropriate position and does not hit the bottom of the cup 208, which may damage the straw 206. A feedback loop can be formed in which measurements from the sensors 260 are communicated to the controller 276 by the controller 262.

Referring next to FIG. 5E, the distal end of the straw 206 can be positioned in one of the ingredient layers, preferably the bottommost layer (e.g., the first ingredient layer 502). FIG. 5E also illustrates the actuator 274 rotating the cup support 272 (e.g., via the mechanism illustrated in FIG. 3), as indicated by the arrow, such that the distal end of the straw 206 is positioned off-center relative to the cup 208 and positioned closer to the sidewall thereof.

The arm 222 can include one or more lateral flanges 523 shaped and sized to, for example, press fit between the inner walls of the housing 204. In particular, the flanges 523 can form a fluid-tight seal with the inner walls and the straw nozzle 240 can form a fluid-tight seal with the straw 206 to define a chamber 535 between the flanges 523 and the straw nozzle 240. The chamber 535 can be fluid-tight except at the opening at the proximal end of the straw 206 and an opening in the inner wall connected to the valve 238. The controller 236 of the gas pumping assembly 230 can operate the pump 234 (e.g., an air pump) to drive gas (e.g., air) from the gas source 232 (e.g., the environment, an air tank not shown in FIG. 5E) through the valve 238 and into the chamber 535. The gas is then driven into the opening at the proximal end of the straw 206, through the length of the straw 206, and out through the opening at the distal end of the straw 206 while the straw nozzle 240 holds onto the straw 206 at a fixed position. Because the distal end of the straw 206 is positioned in the first ingredient layer 502, the gas can bubble through the first and second ingredient layers 502, 504 and thereby agitate the ingredients in the cup 208.

Referring next to FIG. 5F, the pump 234 of the gas pumping assembly 230 can continue pumping gas through the straw 206 while the actuator 274 continues to rotate the cup support 272. Therefore, the gas exits the distal end of the straw 206 at different positions along the bottom perimeter of the cup 208 and continues to agitate the ingredients. Eventually, the first and second ingredients layers 502, 504 are blended into a blended beverage 506 via the gas-induced agitation, and the movement of the cup support 272 enables more uniform blending.

Referring next to FIG. 5G, upon sufficient blending of the ingredients, the gas pumping assembly 230 can cease pumping gas through the straw 206. In some embodiments, the gas-induced agitation continues for a predetermined duration of time. In some embodiments, the gas-induced agitation continues until the controller 262 determines that the ingredients are sufficiently blended based on measurements from the sensors 260 (e.g., based on color, observed viscosity, and/or the like). In some embodiments, a user can manually terminate the gas-induced agitation (e.g., by pressing a button on the ingredient blending device 200).

Subsequently, the actuator 274 of the cup holder assembly 270 can lower the cup support 272, and thus the cup 208, to its original position relative to the base 202. The actuator 224 can then lower the arm 222 further down to push the straw 206 completely out of the housing 204 such that the straw 206 drops into the cup 208. The user (e.g., an employee, a customer) can retrieve the cup 208 with the blended beverage 506 and the straw 206 for consumption. The ingredient blending device 200 can then return to the operation step illustrated in FIG. 5A to prepare another blended beverage, continuing the cycle.

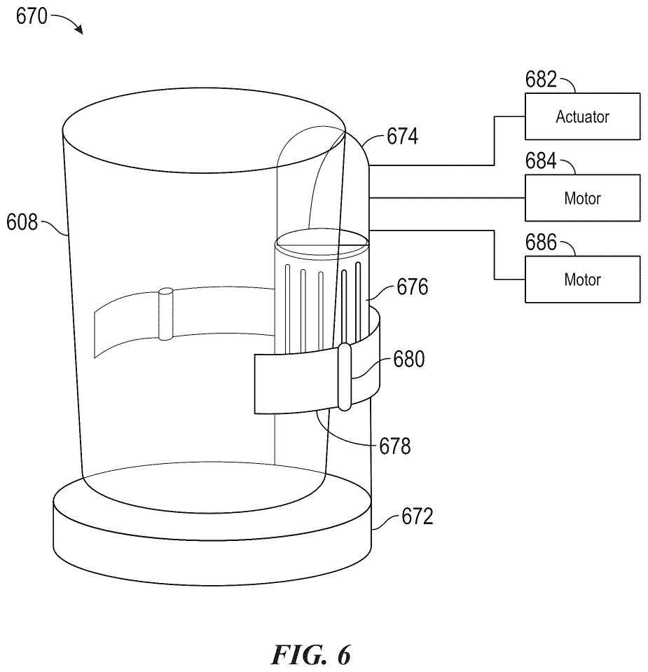

FIG. 6 is a perspective view of a cup holder assembly 670, configured in accordance with embodiments of the present technology. The cup holder assembly 670 can be an example of the cup holder assembly 170 of FIG. 1. In the illustrated embodiment, the cup holder assembly 670 includes a platform 672 including a stem 674, a roller 676 rotatably coupled to the stem 674, and a pair of arms 678 extending from the stem 674. The cup holder assembly 670 can also include an actuator 682, a first motor 684, and a second motor 686. As discussed further herein, the actuator 682, the first motor 684, and the second motor 686 can be operated to move (e.g., lift, tilt, rotate) a cup 608 supported on the cup holder assembly 670 relative to a stationary component of an ingredient blending device that the cup holder assembly 670 is part of.

The platform 672 can include a generally flat, circular component on which the cup 608 can sit. In other embodiments, the platform 672 can have other shapes and sizes. The pair of arms 678 can be curved to at least partially wrap around the cup 608, thereby constraining lateral movement and preventing the cup 608 from falling out of the cup holder assembly 670 during operation. In some embodiments, the arms 678 are rigid such that a user can lower the cup 608 onto the platform 672 from above the arms 678. In some embodiments, the arms 678 are elastic such that a user can push the cup 608 laterally onto the platform 672 and push apart the arms 678, which then spring back to the illustrated shape once the cup 608 is in position.

The first motor 684 can be operable coupled to spin the roller 676 about the longitudinal axis of the roller 676. The roller 676 can be positioned to contact the outer sidewall of the cup 608 and can have a high friction surface (e.g., silicone, rubber) such that rotation of the roller 676 (e.g., via the first motor 684) spins the cup 608 about the longitudinal axis of the cup 608. The arms 678 can each include a roller 680 to facilitate spinning of the cup 608. In some embodiments, the rollers 680 are free-spinning. In some embodiments, the rollers 680 are biased (e.g., via torsion springs) to return the cup 608 to an original orientation.

The actuator 682 can be operably coupled to move the platform 672, and thus the cup 608, in a vertical direction. In some embodiments, an ingredient blending device that the cup holder assembly 670 is part of includes the stationary component and a rail therein along which the actuator 682 can raise and lower the platform 672. The second motor 686 can be operably coupled to tilt the platform 672 and thus the cup 608.

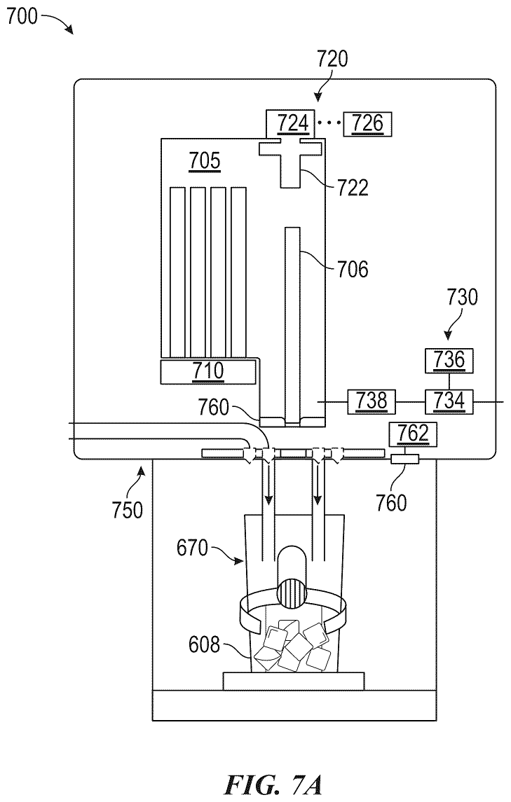

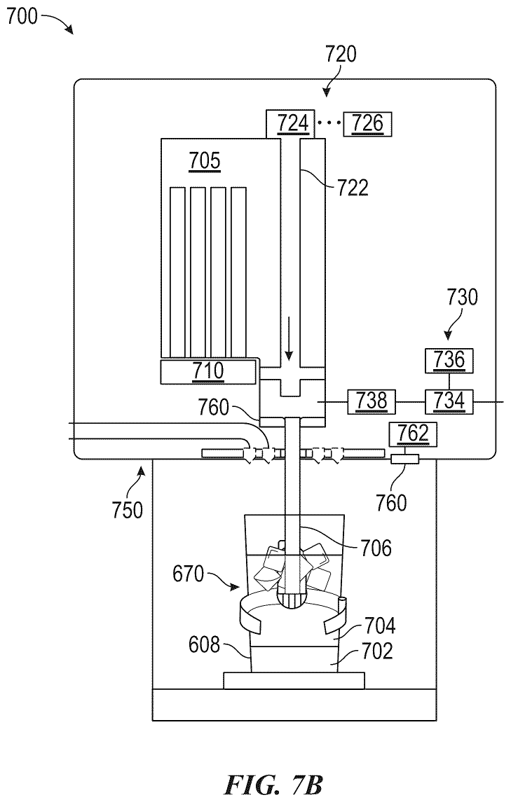

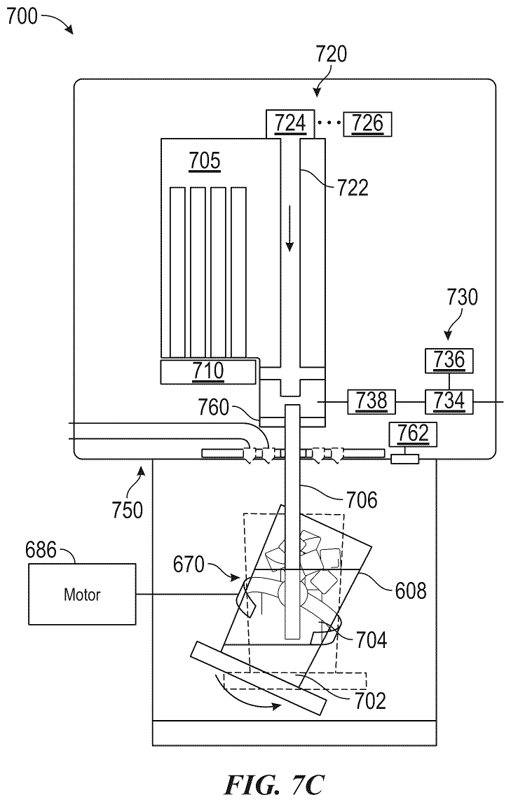

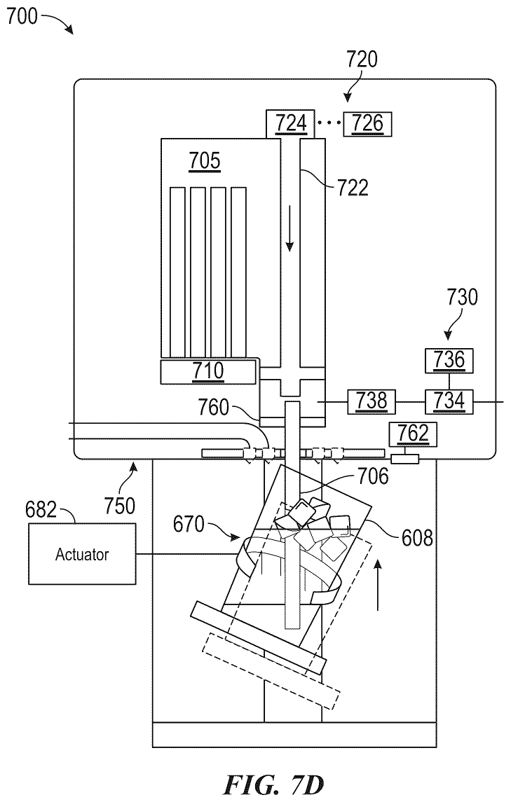

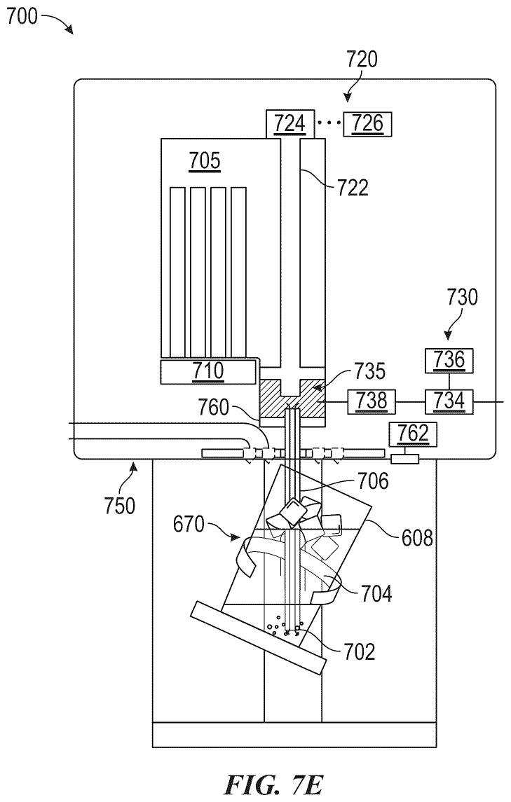

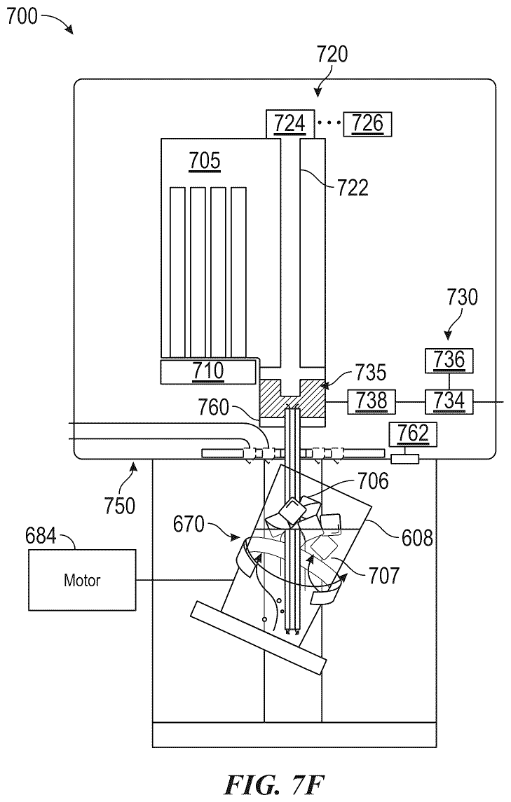

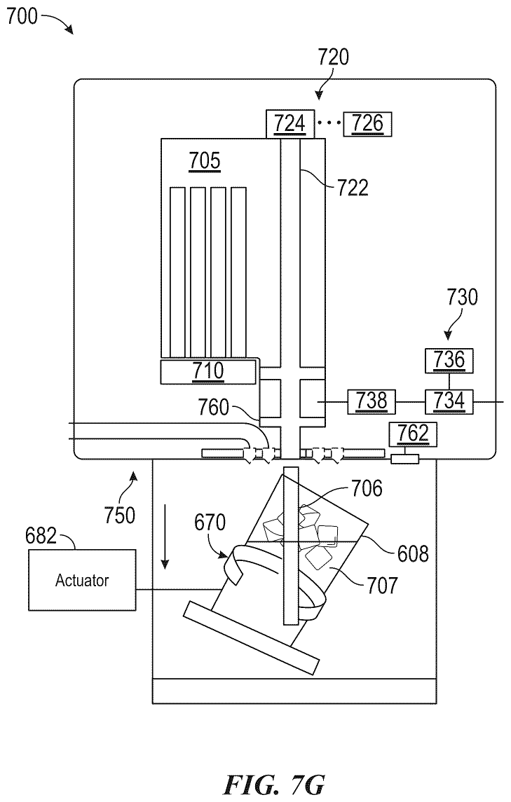

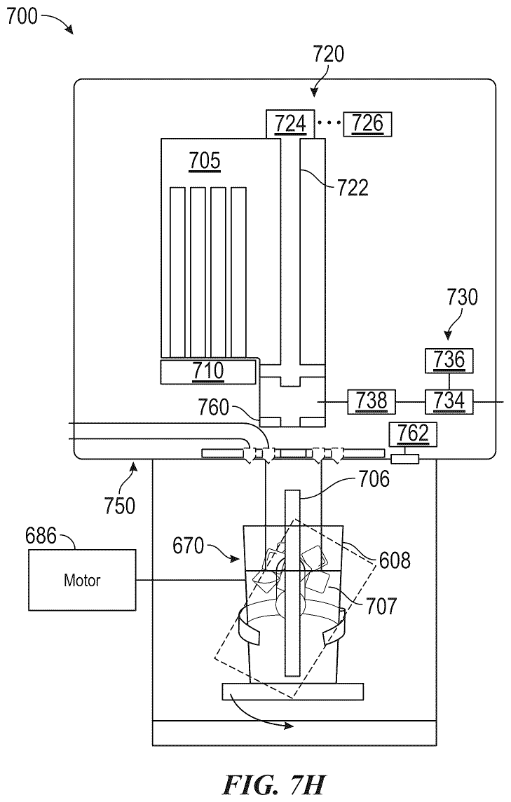

FIGS. 7A-7F illustrate a series of operation steps of an ingredient blending device 700 including the cup holder assembly 670 in accordance with embodiments of the present technology. While the operation steps are illustrated herein in a particular order, it is appreciated that the ingredient blending device 700 can be operated in a different order and/or operated with fewer, alternative, and/or additional steps. Also, unless indicated otherwise, operation of the ingredient blending device 700 can be identical or generally similar to operation of the ingredient blending device 200 as illustrated in FIGS. 5A-5G.

Referring first to FIG. 7A, a user (e.g., a beverage vendor employee, a consumer) can place the cup 608 (optionally pre-filled with ice) on the cup holder assembly 670. An ingredient dispensing assembly 750 can be operated to dispense multiple ingredients to be blended into the cup 608 (e.g., via dispensing nozzles). Different ones of the dispensing nozzles can be coupled to dispense different ingredients. In some embodiments, the ingredients are dispensed in a particular order. In some embodiments, the ingredients are dispensed simultaneously. Also, a straw feeding assembly 710 can be operated to feed (e.g., move) one of the straws 706 from a hopper 705 to a position between an arm 722 of a straw displacement assembly 720 and a straw nozzle 740 as shown. In some embodiments, the straw feeding assembly 710 holds the straw 706 in the illustrated position until the next operation step. In some embodiments, the straw 706 is inserted at least partially into the straw nozzle 740, and the straw nozzle 740 can independently hold the straw 706 in the illustrated position until the next operation step.

Referring next to FIG. 7B, once the ingredient dispensing assembly 750 has completed dispensing the ingredients, the cup 608 may contain different ingredient layers, such as a first ingredient layer 702 at the bottom of the cup 608 and a second ingredient layer 704 above the first ingredient layer 702, that are not yet blended. A controller 726 of the straw displacement assembly 720 can operate an actuator 724 to lower the arm 722 such that the arm 722 contacts a proximal end of the straw 706 and pushes the straw 706 to a lower position as illustrated. In particular, the arm 722 can push the straw 706 partially into the cup 608 until the straw nozzle 740 holds the proximal end of the straw 706 and the distal end of the straw 706 is positioned inside the first ingredient layer 702 and/or the second ingredient layer 704. In some embodiments, one or more sensors 760 can be used to measure the position of the straw 706 (e.g., in real time, at certain points in time) to ensure that the straw 706 is pushed by the arm 722 to the appropriate position. A feedback loop can be formed in which measurements from the sensors 760 are communicated to the controller 726 by a controller 762 operably coupled to the sensors 760. As discussed in further detail herein, the actuator 724 can then raise the arm 722 to form a gap between the proximal end of the straw 706 and the arm 722 as shown.

Referring next to FIG. 7C, The second motor 686 can tilt the platform 672 such that the cup 608 is tilted as shown. The prior orientation of the cup 608 is shown in phantom lines. The second motor 686 can tilt the cup 608 by an angle between 0-45°, such as 5°, 15°, or 25°. In some embodiments, the sensors 760 are used to ensure that the straw 706 points toward a point along the bottom perimeter of the cup 608.

Referring next to FIG. 7D, the actuator 682 can lift the platform 672, and thus the cup 608, as indicated by the arrow such that the distal end of the straw 706 is positioned in one of the ingredient layers, preferably the bottommost layer (e.g., the first ingredient layer 702), and closer to the bottom perimeter of the cup 608. The prior position of the cup 608 is shown in phantom lines.

Referring next to FIG. 7E, the arm 722 and the straw nozzle 740 can form a partially fluid-tight chamber 735 that is open only to the proximal end of the straw 706 and a gas pumping assembly 730. The gas pumping assembly 730 can include a pump 734, a controller 736, and a valve 738 that operate together to pump gas (e.g., air) into the chamber 735. The gas is then driven into the opening at the proximal end of the straw 706, through the length of the straw 706, and out through the opening at the distal end of the straw 706. Because the distal end of the straw 706 is positioned in the first ingredient layer 702, the gas can bubble through the first and second ingredient layers 702, 704 and thereby agitate the ingredients in the cup 608.

Referring next to FIG. 7F, the pump 734 of the gas pumping assembly 730 can continue pumping gas through the straw 706 while the first motor 684 rotates the roller 676 (FIG. 6), thereby spinning the cup 608. Therefore, the gas exits the distal end of the straw 706 along the bottom perimeter of the cup 608 and continues to agitate the ingredients. Eventually, the first and second ingredients layers 702, 704 are blended into a blended beverage 707 via the gas-induced agitation, and the spinning of the cup 608 enables more uniform blending.

Referring next to FIG. 7G, upon sufficient blending of the ingredients, the gas pumping assembly 730 can cease pumping gas through the straw 706. In some embodiments, the gas-induced agitation continues for a predetermined duration of time. In some embodiments, the gas-induced agitation continues until the controller 762 determines that the ingredients are sufficiently blended based on measurements from the sensors 760 (e.g., based on color, viscosity, and/or the like). In some embodiments, a user can manually terminate the gas-induced agitation (e.g., by pressing a button on the ingredient blending device 700). Subsequently, the actuator 682 can lower the platform 672, and thus the cup 608, to its original position (e.g., height). The actuator 724 can then lower the arm 722 further down to push the straw 706 completely out such that the straw 706 drops into the cup 608.

Referring next to FIG. 7H, the second motor 686 can tilt the platform 672, and thus the cup 608, back to its original, upright orientation. The prior orientation of the cup 608 is shown in phantom lines. The user (e.g., an employee, a customer) can retrieve the cup 608 with the blended beverage 707 and the straw 706 for consumption. The ingredient blending device 700 can then return to the operation step illustrated in FIG. 7A to prepare another blended beverage, continuing the cycle.

Compared to the ingredient blending device 200 illustrated in FIGS. 2 and 5A-5G, the ingredient blending device 700 illustrated in FIGS. 7A-7H provides a different mechanism for moving and/or rotating the cup and can also provide a different range of motions (e.g., tilting). These different movements of the cup, in turn, can provide a different blending pattern of the ingredients which may affect flavor, texture, consistency, and/or beverage production speed.

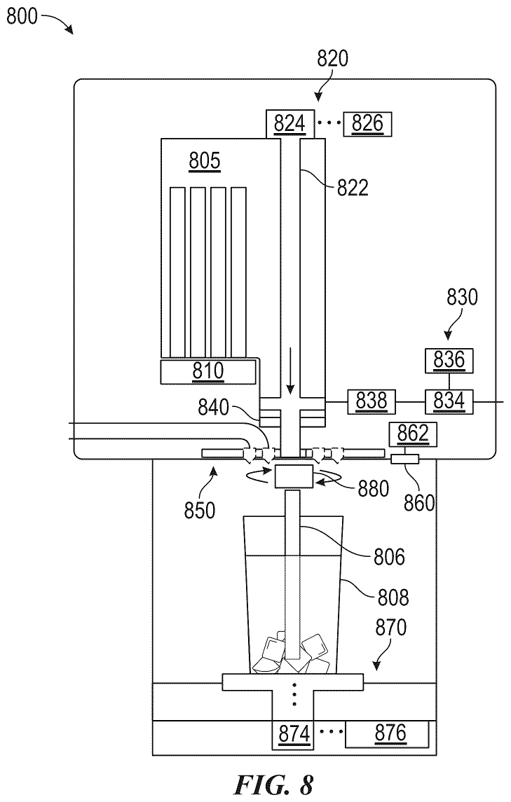

FIG. 8 is a partially schematic illustration of an ingredient blending device 800, configured in accordance with embodiments of the present technology. Unless indicated otherwise, operation of the ingredient blending device 800 can be identical or generally similar to operation of the ingredient blending device 200 as illustrated in FIGS. 5A-5G. In the illustrated embodiment, the ingredient blending device 800 includes a straw feeding assembly 810, a straw displacement assembly 820, a gas pumping assembly 830, and a straw nozzle 840. The ingredient blending device 800 can also include an ingredient dispensing assembly 850, one or more sensors 860, a cup holder assembly 870, and a stirring device 880. As shown, the cup holder assembly 870 can support a cup 808, which may optionally contain ice.

The ingredient dispensing assembly 850 can function similarly to the ingredient dispensing assembly 250, as illustrated in and discussed above with reference to FIG. 5D, to dispense multiple ingredients to be blended into the cup 808. Afterwards, an arm 822 of the straw displacement assembly 820 can push a straw 806 partially or fully out of a hopper 805. The stirring device 880 can be positioned below the arm 822 such that the stirring device 880 can slidably receive and hold onto the straw 806 (e.g., hold onto a proximal end thereof). In particular, the arm 822 can push the straw 806 through the stirring device 880 until the distal end of the straw 806 is positioned in the ingredients contained in the cup 808.

In some embodiments, the stirring device 880 includes an annular member with an opening positioned and sized to receive the straw 806 therethrough. The stirring device 880 can be biased (e.g., via springs) such that the opening can stretch in response to the size of the straw 806. Therefore, the stirring device 880 can receive and securely hold onto straws of various sizes. In some embodiments, the stirring device 880 includes grippers, suction cups, clamps, and/or other mechanisms to receive and hold onto the straw 806. In some embodiments, the stirring device 880 includes a clamp that can grip onto straws of various sizes. In other embodiments, the stirring device 880 can include other mechanisms for receiving and holding onto the straw 806.

In operation, the stirring device 880 can be operated (e.g., via a motor not shown) to rotate the straw 806 about the longitudinal axis of the straw 806 or an axis offset from the longitudinal axis of the straw 806. Rotation of the straw 806 in turn stirs or otherwise rotates the ingredients in the cup 808 (e.g., creating a whirlpool), thereby blending the ingredients. In some embodiments, the stirring continues for a predetermined duration of time. In some embodiments, the stirring continues until a controller 862 determines that the ingredients are sufficiently blended based on measurements from the sensors 860 (e.g., based on color, viscosity, and/or the like). In some embodiments, a user can manually terminate the stirring (e.g., by pressing a button on the ingredient blending device 800).

In some embodiments, the stirring device 880 includes an opening in fluid communication with the gas pumping assembly 830 such that the gas pumping assembly 830 can pump gas through the straw 806. This enables the gas-induced agitation described above with reference to FIGS. 5A-5G and 7A-7H in addition to the stirring described herein to produce a blended beverage. Moreover, in some embodiments, the cup holder assembly 870 and the cup 808 remain stationary during operation. In other embodiments, the cup holder assembly 870 can actuate to move (e.g., lift, tilt, rotate) the cup 808 in conjunction with rotation of the straw 806.

Upon sufficient blending, the arm 822 can be further lowered to push the straw 806 out of the stirring device 880. Alternatively or additionally, the stirring device 880 can be actuated to release the straw 806. Thus, the straw 806 drops into the cup 808, and the user (e.g., an employee, a consumer) can retrieve the cup 808 containing the blended beverage and the straw 806.

It is appreciated that the ingredient blending device 800 can omit one or more of the components illustrated and described herein. For example, in some embodiments, the ingredient blending device 800 omits the gas pumping assembly 830, the straw nozzle 840, and/or the sensors 860. Compared to the ingredient blending devices 200 and 700, the ingredient blending device 800 enables movement of the straw 806 to blend the ingredients. As aforementioned, the cup 808 can remain stationary or can be moved while the straw 806 spins.

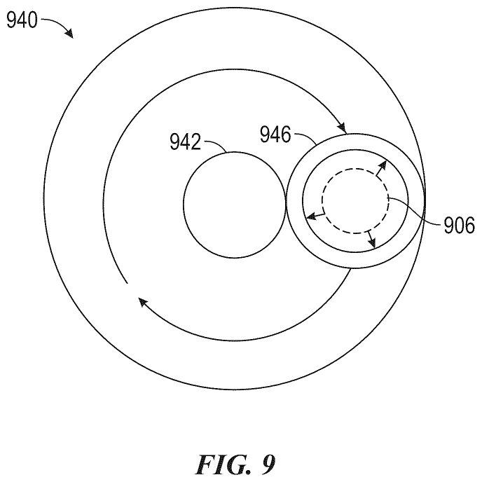

FIG. 9 is a top view of a motorized straw nozzle 940, configured in accordance with embodiments of the present technology. As shown, the motorized straw nozzle 940 can include a gripper 946 and a motor 942 operably coupled to the gripper 946. The gripper 946 can be sized and shaped to receive a straw 906 therethrough and can be actuated (e.g., via an actuator not shown) to selectively grip or release the straw 906. For example, the gripper 946 can be actuated to decrease in diameter to grip the straw 906 and to increase in diameter to release the straw 906. In some embodiments, when gripping the straw 906, the gripper 946 can form a fluid-tight seal therebetween. The motor 942 can be operated to rotate the gripper 946 about an axis off-center from the gripper 946. In the illustrated embodiment, the motor 942 is positioned at the center of the motorized straw nozzle 940, and the gripper 946 is positioned to rotate around the motor 942. In other embodiments, the motor 942 can be positioned elsewhere to rotate the gripper 946, such as via a geartrain.

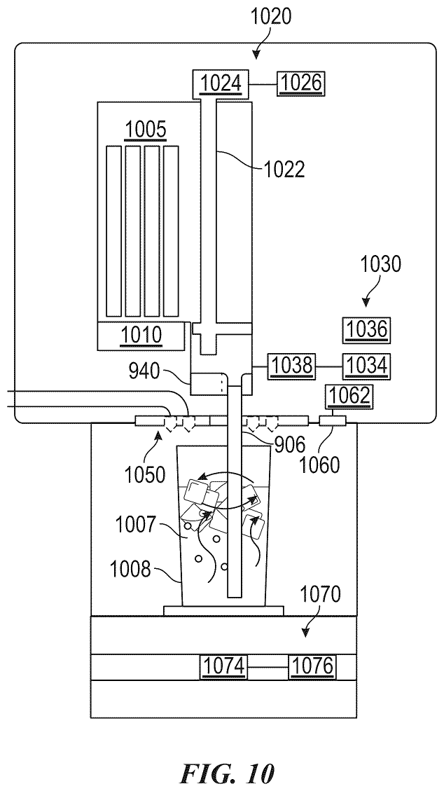

FIG. 10 is a partially schematic illustration of an ingredient blending device 1000 including the motorized straw nozzle 940 and configured in accordance with embodiments of the present technology. Unless indicated otherwise, components and/or operation of the ingredient blending device 1000 can be identical or generally similar to operation of the ingredient blending device 200 as illustrated in FIGS. 5A-5G. In the illustrated embodiment, the ingredient blending device 1000 includes a hopper 1005 for storing straws, a straw feeding assembly 1010, a straw displacement assembly 1020, a gas pumping assembly 1030, and the motorized straw nozzle 940. The ingredient blending device 1000 can also include an ingredient dispensing assembly 1050, one or more sensors 1060, and a cup holder assembly 1070. As shown, the cup holder assembly 1070 can support a cup 1008, which may optionally contain ice.

The straw displacement assembly 1020 can include an arm 1022 (e.g., a piston), an actuator 1024 (e.g., a linear actuator) operably coupled to extend or withdraw the arm 1022, and a controller 1026 operably coupled to control the actuator 1024. The gas pumping assembly 1030 can include a pump 1034 (e.g., an air pump), a controller 1036 operably coupled to control the pump 1034, and a valve 1038 (e.g., a one-way valve) coupled between the pump 1034 and the hopper 1005 (e.g., downstream of the pump 1034). A controller 1062 can be operably coupled to the one or more sensors 1060. The cup holder assembly 1070 can include an actuator 1074 operably coupled to move the cup 1008 and a controller 1076 operably coupled to control the actuator 1074.

The ingredient dispensing assembly 1050 can function similarly to the ingredient dispensing assembly 250, as illustrated in and discussed above with reference to FIG. 5D, to dispense multiple ingredients to be blended into the cup 1008. Afterwards, the straw displacement assembly 1020 can push the straw 906 until a proximal end portion of the straw 906 is in the motorized straw nozzle 940. Referring to FIGS. 9 and 10 together, the gripper 946 can be actuated to grip the proximal end portion of the straw 906, and the motor 942 can be operated to rotate the gripper 946, and thus the straw 906 gripped by the gripper 946, around the axis off-center from the gripper 946 and the straw 906. Therefore, the motorized straw nozzle 940 can blend the ingredients in the cup 1008 to form a blended beverage 1007 by stirring the straw 906. In some embodiments, the gripper 946 forms a fluid-tight seal with the straw 906, and the gas pumping assembly 1030 can pump gas into the straw to further agitate and blend the ingredients in the cup 1008.

Referring to FIGS. 1-10 together, select embodiments of the ingredient blending device are expected to provide several benefits. First, because the blending occurs external to the ingredient blending device, the need to clean components of the device between each beverage produced is eliminated or at least significantly reduced. For example, conventional blending machines repeatedly blend ingredients for different beverages in the same blending container, so the blending container must be cleaned between each beverage produced to avoid cross-contamination. In contrast, embodiments of the present technology dispense the ingredients into and blend the ingredients in the individual cups that are ultimately served to the consumer. Because each new cup serves as the “blending container” for each beverage produced, there is no need to clean the ingredient blending device itself between beverages produced.

Second, because the ingredients are blended in the serving cup using a straw that is ultimately served to the customer, the ingredient blending container can omit certain components included in conventional blending machines. For example, ingredient blending devices configured in accordance with embodiments of the present technology do not require drainage systems. As another example, ingredient blending devices configured in accordance with embodiments of the present technology do not require stirring blades or other blending components that directly contact the ingredients.

Third, because a new straw and a new cup are used to blend the ingredients for each new beverage, ingredient blending devices configured in accordance with embodiments of the present technology inherently have higher hygiene standards and reduced risks of cross-contamination. Because none of the components of the ingredient blending device directly contact any of the ingredients, the risk of bacteria growing in the ingredient blending device and the risk of ingredients for one beverage transferring to another beverage (e.g., cross-contamination) is eliminated or at least significantly reduced.

Fourth, by using the straw that is ultimately served to the customer with the blended beverage to blend the ingredients, as opposed to using an additional disposable component, ingredient blending devices configured in accordance with embodiments of the present technology reduce unnecessary waste. Straws are commonly used by consumers for many beverages, and serving a straw with the beverage can be particularly appealing and convenient to consumers.

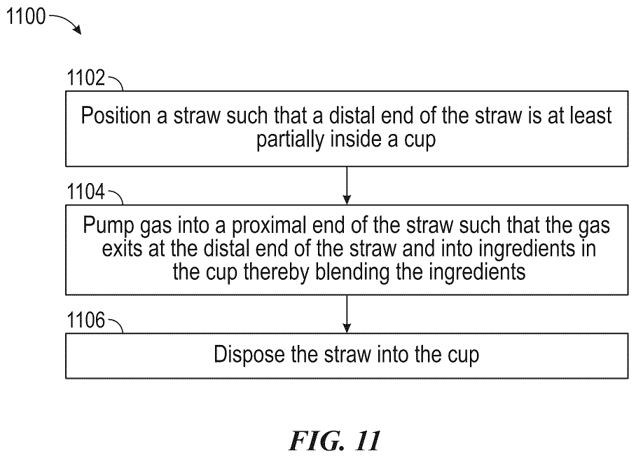

FIG. 11 is a flowchart illustrating a method 1100 for preparing a blended beverage in accordance with embodiments of the present technology. While the steps of the method 1100 are described below in a particular order, one or more of the steps can be performed in a different order or omitted, and the method 1100 can include additional and/or alternative steps. Additionally, although the method 1100 may be described below with reference to the embodiments of the present technology described herein, the method 1100 can be performed with other embodiments of the present technology.

The method 1100 begins at block 1102 by positioning a straw (e.g., the straw 206 of FIG. 2) such that a distal end of the straw is at least partially inside a cup (e.g., the cup 208 of FIG. 2). In some embodiments, positioning the straw comprises defining a chamber (e.g., the chamber 535 of FIG. 5E) that fluidly connects a gas source (e.g., the gas source 232 of FIG. 2) and the proximal end of the straw.

At block 1104, the method 1100 continues by pumping gas into a proximal end of the straw such that the gas exits at the distal end of the straw and into ingredients in the cup, thereby blending the ingredients. In some embodiments, pumping the gas comprises pumping the gas from the gas source and into the proximal end of the straw via the chamber.

At block 1106, the method 1100 continues by dispensing the straw into the cup. The cup containing the blended beverage and the straw can then be retrieved for consumption.

The method 1100 can further include moving the cup relative to the straw. In some embodiments, moving the cup comprises rotating the cup about a pivot (e.g., the pivot 373 of FIG. 3) offset from a center of the cup. In some embodiments, moving the cup comprises (i) lifting the cup in a vertical direction (e.g., via the actuator 682 of FIG. 6), (ii) tilting the cup about a horizontal axis (e.g., via the second motor 686 of FIG. 6), and (iii) spinning the cup about a longitudinal axis of the cup (e.g., via the first motor 684 of FIG. 6). The method 1100 can further include rotating the straw about a longitudinal axis of the straw (or a different axis) (e.g., via the stirring device 880 of FIG. 8). The method 1100 can further include measuring, via one or more sensors (e.g., the sensors 260 of FIG. 2), a position of the straw relative to the cup. In such embodiments, positioning the straw can be based at least in part on the measured position of the straw relative to the cup.

### Computer Systems

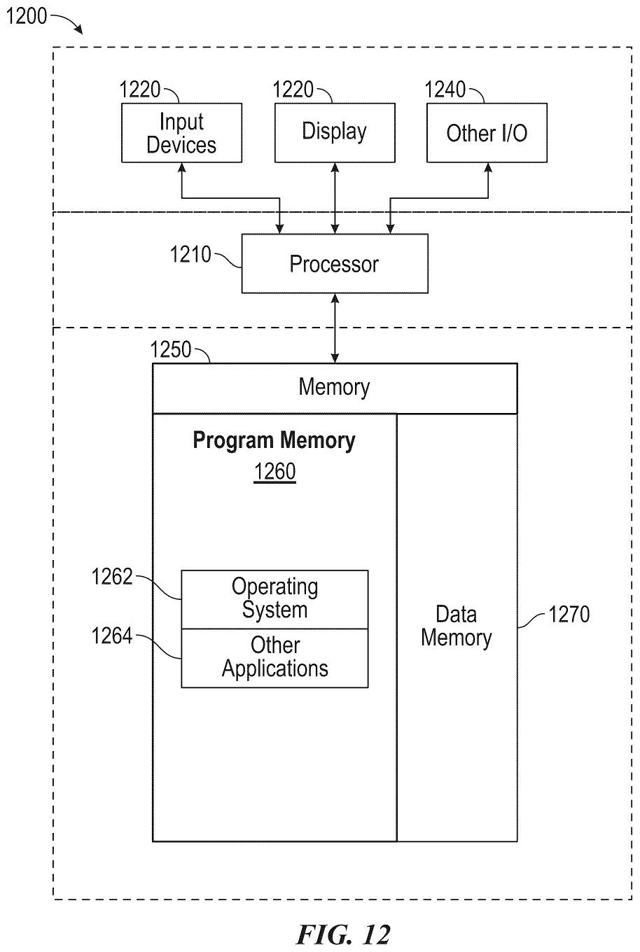

Several implementations are discussed below in more detail in reference to the Figures. FIG. 12 is a block diagram illustrating an overview of devices on which some implementations of the disclosed technology can operate. The devices can comprise hardware components of a device 1200 that execute customized queries created from user selections of query elements that are based on metadata from data set registrations. Device 1200 can include one or more input devices 1220 that provide input to the Processor(s) 1210 (e.g., CPU(s), GPU(s), HPU(s), etc.), notifying it of actions. The actions can be mediated by a hardware controller that interprets the signals received from the input device and communicates the information to the processors 1210 using a communication protocol. Input devices 1220 include, for example, a mouse, a keyboard, a touchscreen, an infrared sensor, a touchpad, a wearable input device, a camera- or image-based input device, a microphone, or other user input devices.

Processors 1210 can be a single processing unit or multiple processing units in a device or distributed across multiple devices. Processors 1210 can be coupled to other hardware devices, for example, with the use of a bus, such as a PCI bus or SCSI bus. The processors 1210 can communicate with a hardware controller for devices, such as for a display 1230. Display 1230 can be used to display text and graphics. In some implementations, display 1230 provides graphical and textual visual feedback to a user. In some implementations, display 1230 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 1240 can also be coupled to the processor, such as a network card, video card, audio card, USB, firewire or other external device, camera, printer, speakers, CD-ROM drive, DVD drive, disk drive, or Blu-Ray device.

In some implementations, the device 1200 also includes a communication device capable of communicating wirelessly or wire-based with a network node. The communication device can communicate with another device or a server through a network using, for example, TCP/IP protocols. Device 1200 can utilize the communication device to distribute operations across multiple network devices.

The processors 1210 can have access to a memory 1250 in a device or distributed across multiple devices. A memory includes one or more of various hardware devices for volatile and non-volatile storage and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 1250 can include program memory 1260 that stores programs and software, such as an operating system 1262 and other application programs 1264. Memory 1250 can also include data memory 1270, e.g., predetermined operating parameters relating to gas pumping, straw displacement, etc., corresponding to the table data, column data, value filter data, user interface data, database element data, selection data, root table data, code snippet data, join query data, query template data, connection data, configuration data, settings, user options or preferences, etc., which can be provided to the program memory 1260 or any element of the device 1200.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

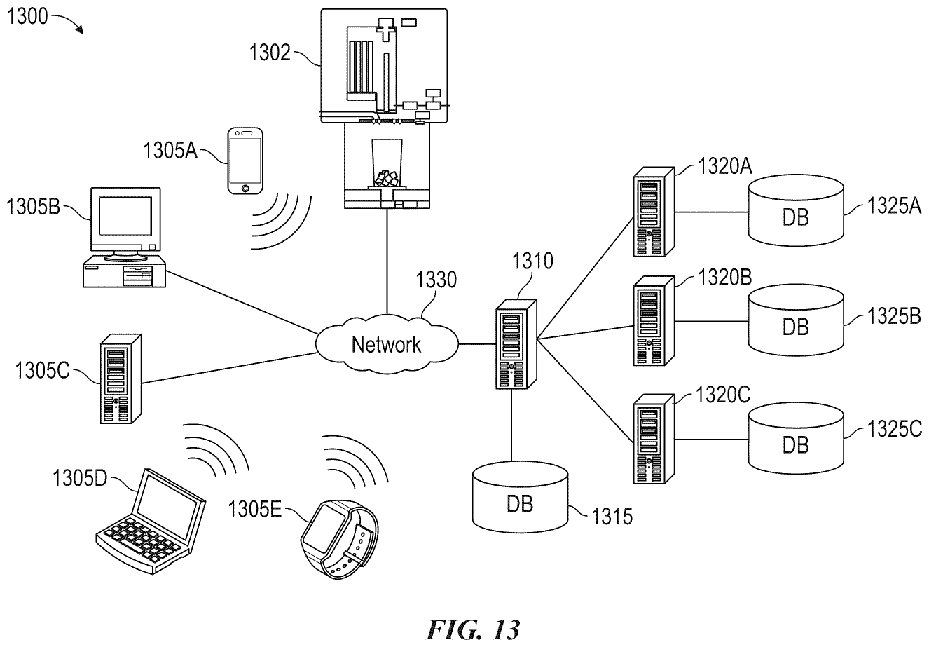

FIG. 13 is a block diagram illustrating an overview of an environment 1300 in which some implementations of the disclosed technology can operate. Environment 1300 can include one or more client computing devices 1305A-E (collectively referred to as “client computing devices 1305”) and an ingredient blending device 1302. Client computing devices 1305 and the ingredient blending device 1302 can operate in a networked environment using logical connections through network 1330 to one or more remote computers, such as a server computing device.

In some implementations, server 1310 can be an edge server which receives client requests and coordinates fulfillment of those requests through other servers, such as servers 1320A-C. Server computing devices 1310 and 1320 can comprise computing systems, such as device 1200. Though each server computing device 1310 and 1320 is displayed logically as a single server, server computing devices can each be a distributed computing environment encompassing multiple computing devices located at the same or at geographically disparate physical locations. In some implementations, each server 1320 corresponds to a group of servers.

Client computing devices 1305 and server computing devices 1310 and 1320 can each act as a server or client to other server/client devices. Server 1310 can connect to a database 1315. Servers 1320A-C can each connect to a corresponding database 1325A-C. As discussed above, each server 1320 can correspond to a group of servers, and each of these servers can share a database or can have their own database. Databases 1315 and 1325 can warehouse (e.g., store) information such as table data, column data, value filter data, user interface data, database element data, selection data, root table data, code snippet data, join query data, query template data, and/or connection data. Though databases 1315 and 1325 are displayed logically as single units, databases 1315 and 1325 can each be a distributed computing environment encompassing multiple computing devices, can be located within their corresponding server, or can be located at the same or at geographically disparate physical locations.

Network 1330 can be a local area network (LAN) or a wide area network (WAN) but can also be other wired or wireless networks. Network 1330 may be the Internet, a mobile phone network, a mobile voice or data network (e.g., a 5G or Long Term Evolution (LTE) network), a cable network, a public switched telephone network, a short-range wireless communication network (e.g., Bluetooth or Near Field Communications (NFC)), or some other public or private network. Client computing devices 1305 can be connected to network 1330 through a wired or wireless network interface, such as a satellite path, a fiber-optic path, a cable path, a path that supports Internet communications (e.g., Internet Protocol television (IPTV)), free-space connections (e.g., for broadcast or other wireless signals), etc. While the connections between server 1310 and servers 1320 are shown as separate connections, these connections can be any kind of local, wide area, wired, or wireless network, including network 1330 or a separate public or private network. As described in further detail herein, the client computing devices 1305 and the ingredient blending device 1302 can operate according to an edge computing protocol (e.g., an edge computing decryption protocol).

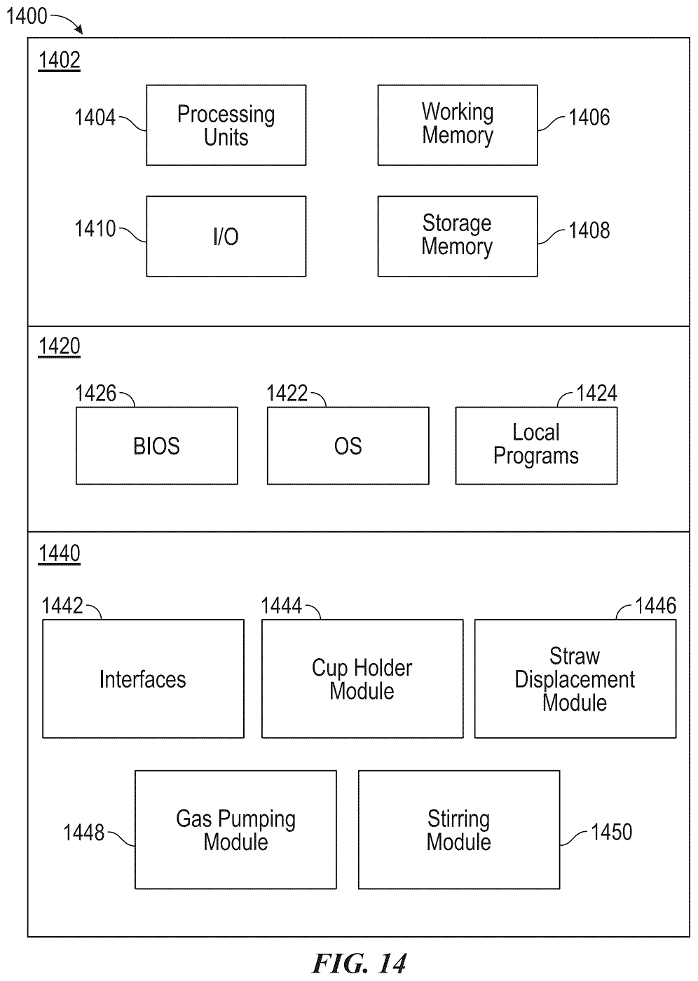

FIG. 14 is a block diagram illustrating components 1400 which, in some implementations, can be used in a system employing the disclosed technology. In some implementations, some or all of the components 1400 can be included in an ingredient blending device or system. The components 1400 include hardware 1402, general software 1420, and specialized components 1440. As discussed above, a system implementing the disclosed technology can use various hardware including processing units 1404 (e.g., CPUs, GPUs, APUs, etc.), working memory 1406, storage memory 1408 (local storage or as an interface to remote storage, such as storage 1315 or 1325), and input and output devices 1410. In various implementations, storage memory 1408 can be one or more of: local devices, interfaces to remote storage devices, or combinations thereof. For example, storage memory 1408 can be a set of one or more hard drives (e.g., a redundant array of independent disks (RAID)) accessible through a system bus or can be a cloud storage provider or other network storage accessible via one or more communications networks (e.g., a network accessible storage (NAS) device, such as storage 1315 or storage provided through another server 1320). Components 1400 can include a machine-readable storage medium having machine executable instructions stored thereon. Components 1400 can be implemented in a client computing device such as client computing devices 1305, on the ingredient blending device 1302, or on a server computing device, such as server computing device 1310 or 1320.

General software 1420 can include various applications including an operating system 1422, local programs 1424, and a basic input output system (BIOS) 1426. Specialized components 1440 can be subcomponents of a general software application 1420, such as local programs 1424. Specialized components 1440 can include cup holder module 1444, straw displacement module 1446, gas pumping module 1448, and stirring module 1450, and components which can be used for providing user interfaces, transferring data, and controlling the specialized components, such as interfaces 1442. In some implementations, components 1400 can be in a computing system that is distributed across multiple computing devices or can be an interface to a server-based application executing one or more of specialized components 1440. Although depicted as separate components, specialized components 1440 may be logical or other nonphysical differentiations of functions and/or may be submodules or code-blocks of one or more applications.

In some implementations, the cup holder module 1444 is configured to manage movement of a cup by, e.g., controlling operation of a cup holder assembly. For example, the cup holder module 1444 can rotate, tilt, and/or spin the cup by operating one or more motors or actuators of the cup holder assembly based on the desired blending sequence.

In some implementations, the straw displacement module 1446 is configured to manage movement of a straw by, e.g., controlling operation of a straw displacement assembly. For example, the straw displacement module 1446 can push, pull, and/or hold in position the straw by operating one or more motors or actuators of the straw displacement assembly based on the desired blending sequence.

In some implementations, the gas pumping module 1448 is configured to manage flow of gas (e.g., air) by, e.g., controlling operation of a gas pumping assembly. For example, the gas pumping module 1448 can control the flow rate and timing of gas through the straw and into ingredients in the cup by operating one or more pumps of the gas pumping assembly based on the desired blending sequence.

In some implementations, the stirring module 1450 is configured to manage stirring of ingredients by, e.g., controlling operation of a stirring device. For example, the stirring module 1450 can stir the ingredients using the straw by operating one or more motors or actuators of the stirring device based on the desired blending sequence.

Those skilled in the art will appreciate that the components illustrated in FIGS. 12-14 described above may be altered in a variety of ways. For example, either of the cup holder module 1444 or the stirring module 1450 may be omitted. In some implementations, one or more of the components described above can execute one or more of the processes described above.

### CONCLUSION

It will be apparent to those having skill in the art that changes may be made to the details of the above-described embodiments without departing from the underlying principles of the present disclosure. In some cases, well-known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Throughout this disclosure, the singular terms “a,” “an,” and “the” include plural referents unless the context clearly indicates otherwise. Additionally, the term “comprising,” “including,” and “having” should be interpreted to mean including at least the recited feature(s) such that any greater number of the same feature and/or additional types of other features are not precluded.

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numbers expressing concentrations, shear strength, and other numerical values used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10, i.e., any and all subranges having a minimum value of equal to or greater than 1 and a maximum value of equal to or less than 10, e.g., 5.5 to 10.

The disclosure set forth above is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

I/We claim:

1. An ingredient blending device, comprising:
a cup holder assembly configured to support a cup;
a straw displacement assembly positioned to move a straw relative to the cup;
a stirring mechanism operably coupled to at least one of the cup holder assembly or the straw; and
a controller operably coupled to the straw displacement assembly and the stirring mechanism, wherein the controller is configured to:
operate the straw displacement assembly to position the straw such that a distal end of the straw is at least partially inside the cup;
operate the stirring mechanism to stir ingredients in the cup; and
operate the straw displacement assembly to dispense the straw into the cup.

2. The ingredient blending device of claim 1, wherein the stirring mechanism is operably coupled to the cup holder assembly, and wherein the controller is configured to operate the stirring mechanism to stir the ingredients in the cup by moving the cup holder assembly relative to the straw.

3. The ingredient blending device of claim 1, wherein the stirring mechanism is operably coupled to the straw, and wherein the controller is configured to operate the stirring mechanism to stir the ingredients in the cup by moving the straw relative to the cup.

4. The ingredient blending device of claim 1, further comprising a gas pumping assembly positioned to pump gas through the straw, wherein the controller is operably coupled to the gas pumping assembly, and wherein the controller is further configured to operate the gas pumping assembly to pump the gas into a proximal end of the straw such that the gas exits at the distal end of the straw and into the ingredients in the cup, thereby blending the ingredients.

5. An ingredient blending device, comprising:
a cup holder assembly configured to support a cup;
a straw displacement assembly positioned to move a straw relative to the cup; and
a controller operably coupled to the cup holder assembly and the straw displacement assembly, wherein the controller is configured to:
operate the straw displacement assembly to position the straw such that a distal end of the straw is at least partially inside the cup;
operate the cup holder assembly to move the cup relative to the straw; and
operate the straw displacement assembly to dispense the straw into the cup.

6. The ingredient blending device of claim 5, further comprising a gas pumping assembly positioned to pump gas through the straw, wherein the controller is operably coupled to the gas pumping assembly, and wherein the controller is further configured to:
operate the straw displacement assembly to position the straw such that a proximal end of the straw is adjacent the gas pumping assembly; and
operate the gas pumping assembly to pump the gas into the proximal end of the straw such that the gas exits at the distal end of the straw and into the ingredients in the cup, thereby blending the ingredients.

7. The ingredient blending device of claim 6, further comprising a straw nozzle positioned to (i) slidably receive the straw as the straw displacement assembly positions the straw and (ii) hold onto the straw at a fixed position to form a fluid-tight seal therebetween as the gas pumping assembly pumps the gas into the proximal end of the straw.

8. The ingredient blending device of claim 6, wherein the gas pumping assembly comprises:
a pump positioned to pump the gas towards the proximal end of the straw; and
a one-way valve positioned downstream of the pump.

9. The ingredient blending device of claim 5, further comprising:
a hopper storing a plurality of straws; and
a straw feeding assembly, wherein the controller is further operably coupled to the straw feeding assembly and configured to operate the straw feeding assembly to move one of the straws from the hopper to a position between the straw displacement assembly and the cup holder assembly.

10. The ingredient blending device of claim 5, further comprising an ingredient dispensing assembly, wherein the controller is further operably coupled to the ingredient dispensing assembly and configured to operate the ingredient dispensing assembly to dispense the ingredients to be blended into the cup.

11. The ingredient blending device of claim 5, further comprising one or more sensors positioned to measure a position of the straw relative to the cup, wherein the one or more sensors and the straw displacement assembly form a feedback loop.

12. The ingredient blending device of claim 5, wherein the straw displacement assembly comprises:
an arm configured to push against a proximal end of the straw; and
an actuator operably coupled to move the arm towards and away from the cup holder assembly.

13. The ingredient blending device of claim 12, further comprising:
a gas pumping assembly positioned to pump gas through the straw; and
a straw nozzle positioned to slidably receive the straw as the arm pushes against the straw,
wherein the arm includes a lateral flange, and
wherein, when the arm positions the straw such that the proximal end of the straw is adjacent the gas pumping assembly, the lateral flange of the arm, the straw nozzle around the straw, and inner walls of the ingredient blending device form a chamber that fluidly connects the gas pumping assembly and the proximal end of the straw.

14. The ingredient blending device of claim 5, wherein cup holder assembly comprises:
a cup support configured to support the cup; and
an actuator configured to rotate the cup support about a pivot offset from a center of the cup support.

15. The ingredient blending device of claim 5, wherein cup holder assembly comprises:
a platform configured to support the cup;
a pair of arms coupled to the platform and positioned to constrain lateral movement of the cup;
a roller rotatably coupled to the platform and positioned to contact an outer sidewall of the cup;
a first motor operably coupled to rotate the roller and thereby spin the cup about a longitudinal axis of the cup;
a second motor operably coupled to tilt the cup support about a lateral axis; and
an actuator operably coupled to move the platform in a vertical direction.

16. An ingredient blending device, comprising:
a cup holder assembly configured to support a cup;
a straw displacement assembly positioned to move a straw relative to the cup;
a stirring device positioned to slidably receive the straw; and
a controller operably coupled to the straw displacement assembly and the stirring device, wherein the controller is configured to:
operate the straw displacement assembly to position the straw such that a proximal end of the straw is held by the stirring device and a distal end of the straw is at least partially inside the cup;
operate the stirring device to rotate the straw, thereby blending ingredients in the cup; and
operate the straw displacement assembly to dispense the straw out of the stirring device and into the cup.

17. The ingredient blending device of claim 16, further comprising a cup holder assembly including:
a cup support configured to support the cup; and
an actuator configured to move the cup support.

18. The ingredient blending device of claim 16, further comprising a gas pumping assembly, wherein the controller is further operably coupled to the gas pumping assembly and configured to operate the gas pumping assembly to pump gas into the proximal end of the straw such that the gas exits at a distal end of the straw and into the ingredients in the cup, thereby agitating the ingredients.

19. The ingredient blending device of claim 16, wherein the controller is configured to operate the stirring device to rotate the straw about a longitudinal axis of the straw.

20. A method for producing a blended beverage, the method comprising:
positioning a straw such that a distal end of the straw is at least partially inside a cup;
pumping gas into a proximal end of the straw such that the gas exits at the distal end of the straw and into ingredients in the cup, thereby blending the ingredients; and
dispensing the straw into the cup.

21. The method of claim 20, further comprising moving the cup relative to the straw, wherein moving the cup comprises rotating the cup about a pivot offset from a center of the cup.

22. The method of claim 20, further comprising moving the cup relative to the straw, wherein moving the cup comprises:
lifting the cup in a vertical direction;
tilting the cup about a horizontal axis; and
spinning the cup about a longitudinal axis of the cup.

23. The method of claim 20, further comprising rotating the straw about a longitudinal axis of the straw.

24. The method of claim 20, wherein positioning the straw comprises defining a chamber that fluidly connects a gas source and the proximal end of the straw, and wherein pumping the gas comprises pumping the gas from the gas source and into the proximal end of the straw via the chamber.

25. The method of claim 20, further comprising measuring, via one or more sensors, a position of the straw relative to the cup, wherein positioning the straw is based at least in part on the measured position of the straw relative to the cup.
